(19) United States
(12) Patent Application Publication
(10) Pub. No.: US 2010/0221551 A1
(43) Pub. Date: Sep. 2, 2010

(54) MULTILAYER FOIL

(75) Inventors: Roland WURSCHE, Duelmen (DE); Sonja Bollmann, Haltern am See (DE); Martin Wielpuetz, Muenster (DE); Kirsten Alting, Muenster (DE); Harald Haeger, Freigericht (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/780,595

(22) Filed: May 14, 2010

Related U.S. Application Data
(62) Division of application No. 10/589,264, filed on Aug. 14, 2006.

(30) Foreign Application Priority Data
Jun. 16, 2004 (DE) 10 2004 029 217.5

(51) Int. Cl. B32B 27/34; B32B 27/38

(52) U.S. Cl. 428/413; 428/476.3

(57) ABSTRACT

The present invention relates to a composite part containing (i) a part composed of an ABS molding composition, and (ii) a multilayer film including at least one layer comprising a polyamide molding composition, and at least one layer comprising an adhesion promoter, wherein the adhesion promoter contains from 2 to 100% by weight of a copolymer, and wherein the copolymer contains (a) from 70 to 99.9% by weight of monomer units derived from vinyl compounds selected from the group consisting of acrylic acid derivatives, methacrylic acid derivatives, and vinylaromatics; and (b) from 0.1 to 30% by weight of monomer units comprising a functional group selected from the group consisting of a carboxylic anhydride group, an epoxy group, and an oxazoline group.

The present invention relates to a multilayer film which comprises at least one layer composed of a polyamide (PA), and also comprises a specific adhesion promoter, and which is suitable for bonding to ABS as substrate material.

The current standard process for decoration of external areas on automobiles is painting. However, this procedure firstly generates high manufacturing costs, resulting from provision of specific plant and the operating cost associated therewith for the automobile producer, and secondly causes pollution of the environment. Pollution of the environment derives by way of example from solvent constituents released from the paints used, and also from accumulation of paint residues, which have to follow correct disposal routes.

Another factor is that painting has only limited suitability for decorating the surfaces of plastics components, which in recent years have become more popular in automobile construction, because of the saving in weight and cost.

The process of painting plastics components which are components of bodywork can, for example, be carried out on-line, the plastics part being subjected to a paint treatment identical with that for the metallic components. This leads to a uniform color, but is attended by high temperatures resulting from the cathodic electrodeposition method conventional here, and this makes the selection of material more difficult. In addition, identical adhesion of the paint formulation has to be ensured on very different substrates. If the process of painting the plastics parts is carried out in a separate step (known as off-line painting), comprising process conditions more advantageous for plastics, the problem of colormatching arises, meaning that the shade achieved on the metal has to be matched precisely. However, the differences in substrate and in the underlying paint formulation that can be used, and process conditions, make this very difficult to achieve. If there is a color difference prescribed via the design, a serious disadvantage that remains is provision of a second set of painting equipment for the plastics parts and the cost associated therewith, and additional time required for manufacture of the automobile also has to be considered. Direct use of the untreated, generally injection-molded plastics parts is aesthetically disadvantageous, because surface defects resulting from the process, such as weld lines, air inclusions, and also necessary reinforcing fillers, such as glass fibers, are clearly discernible here. This is intolerable in visible regions. Consequently, improvement of surface quality has to be undertaken, for example in the context of a painting process, frequently requiring much work for pretreatment via polishing and application of relatively thick layers of a primer.

One proposed solution consists in the use of multilayered plastics films, used to cover the components and then requiring no painting. The bond between substrate and decorating film here can be achieved via a number of manufacturing processes. By way of example, the film can be laminated to the substrate, or it is possible to select a process of reverse coating by an injection-molding process, in which the film is placed in the injection mold during component production. The concept of a film as carrier of decoration is also in line with a trend toward individualization of design elements on automobiles. Specifically, this trend leads to a wider range of models in the manufacturing process, but with a reduction in the number of respective components manufactured per series. The use of films permits rapid, problem-free design change, and can therefore meet this challenge. An important factor here is that the film complies with the standards demanded in the automobile industry with respect to surface properties (class A surface), solvent resistance, and appearance.

Decorative films of this type are in principle known. EP 0 949 120 A1 describes by way of example decorative films with polyalkyl methacrylate as base layer, and these can also comprise a polyamide support layer on the substrate side, while WO 94/03337 discloses decorative films whose base layer can be composed of a wide variety of polymer alternatives, among which is polyamide.

Polyamides, in particular polyamides based on PA12 or PA612, have a property profile, for example impact resistance and chemicals resistance, giving them good suitability for production of decorative films of this type. Paint systems have an underlying tendency toward brittle fracture. If a plastics component decorated in this way is exposed to impact, the crack propagates from the paint layer into the substrate situated thereunder, the result being damage extending far into the material. In contrast, the use in particular of materials with low-temperature impact resistance in a decorative film covering the substrate avoids damage to outer skin and substrate. A fact which has to be considered here is that sufficient chemicals resistance, in particular with respect to engine fuels, oils, and fats must be achieved simultaneously. These requirements are met by polyamides such as PA 12, PA 11 or PA 612. Polyamides which contain aliphatic structures moreover have advantageous UV aging performance. This means that the tendency toward yellowing is only very slight and cannot lead to undesired color changes during the course of the lifetime of an automobile. This combination of properties cannot be generated in the same way by other plastics. Another factor which has to be considered, alongside advantageous properties of the decorated molding, is the suitability of a film of this type with respect to economically advantageous processing methods. A particular factor to be emphasized here in the case of polyamides is good thermoforming performance. The reason for this is that the polyamide materials have inherently high tensile strain at break, which gives them an advantage over other materials.

An object, in the overall context of the application, is to find a suitable adhesion promoter which permits coupling of the polyamide layer to the substrate. A frequently utilized substrate material is ABS or its blend with polycarbonate (PC), which in some cases has reinforcement via glass fibers or via other fillers. The adhesion promoter has to be suitable for processing in a coextrusion process to give a layer within a multilayer film. The composite of this multilayer film with the substrate material can then by way of example be produced via reverse coating by an injection-molding method, or via lamination. A factor applicable not only during the coextrusion process to give the multilayer film but also during reverse coating by an injection-molding method or during lamination is that increased requirements are placed here upon the bonding power of the adhesion promoter, because there is no forced mixing of the components permitting complete consumption of reactive groups at the phase boundary by way of continuous surface renewal. Furthermore, for example during reverse coating by an injection-molding method, the time for which the temperature in the contact zone of the adherends is sufficiently high to achieve formation of a composite is only short. The two abovementioned specifications provide no help toward achievement of this object.

U.S. Pat. No. 3,561,493 discloses that two layers composed of various polymers can be bonded via an intermediate layer which is composed of a mixture of these polymers, by means of coextrusion. However, this teaching is not transferable to the polyamide/ABS system. The outcome of U.S. Pat. No. 3,561,493 applies only to a multilayer tube system in which a polyethylene layer is made to adhere to a PA 11 via use of a blend composed of the two materials. It was impossible to transfer this teaching to bonding between polyamide or a polyether block amide derived therefrom and ABS, because no composition could be found that provided adequate, reliable adhesion to the two materials.

Furthermore, EP 0 322 558 A2 describes blends composed of amorphous polyamide and ABS. EP 0 601 752 A1 describes the use of these blends as adhesion promoters for the amorphous PA/ABS system. These compounded adhesion-promoter materials can be used in coextruded multilayer films. However, experiments have shown that this concept cannot be successfully applied for semicrystalline polyamides, e.g. PA12 or polyether block amide (PEBA) derived from PA12, because blends of this type of composition do not achieve reliable adhesion to the two materials in the desired composite system.

An object was therefore to develop a coextruded adhesion promoter for coupling of polyamides in general and in particular of polyamides based on PA12 to ABS.

This object, and other objects apparent hereinafter, are achieved via the use of an adhesion promoter for production of a bond between

I. a layer composed of a polyamide molding compound, and
II. a part composed of an ABS molding composition,
where the adhesion promoter comprises from 2 to 100% by weight of a copolymer which contains the following monomer units:
1. from about 70 to about 99.9% by weight of monomer units which derive from vinyl compounds selected from acrylic acid derivatives, methacrylic acid derivatives, and vinylaromatics, and also
2. from about 0.1 to about 30% by weight of monomer units which contain a functional group selected from a carboxylic anhydride group, an epoxy group, and an oxazoline group.

There is no restriction on the polyamide of the layer I. Polyamides that can be used are mainly aliphatic homo- and copolycondensates, such as PA 46, PA 66, PA 88, PA 610, PA 612, PA 810, PA 1010, PA 1012, PA 1212, PA 6, PA 7, PA 8, PA 9, PA 10, PA 11 and PA 12. (The terminology for the polyamides corresponds to an international standard where the first numeral(s) give(s) the carbon number of the starting diamine and the second numeral(s) give(s) the carbon number of the dicarboxylic acid. If only one numeral is given, this means that the starting material was an ∀,T-aminocarboxylic acid or the lactam derived therefrom; for further information reference may be made to H. Domininghaus, Die Kunststoffe and ihre Eigenschaften [Plastics and their properties], pp. 272 ff., VDI-Verlag, 1976.)

If copolyamides are used these may contain, by way of example, adipic acid, sebacic acid, suberic acid, isophthalic acid, terephthalic acid, naphthalene-2,6-dicarboxylic acid, etc. as coacid and, respectively, bis(4-aminocyclohexyl)methane, trimethylhexamethylenediamine, hexamethylenediamine or the like as codiamine. There may also be lactams, such as caprolactam or laurolactam, or aminocarboxylic acids, such as T-aminoundecanoic acid, incorporated as cocomponent.

The preparation of these polyamides is known (e.g. D. B. Jacobs, J. Zimmeimann, Polymerization Processes, pp. 424-467, Interscience Publishers, New York, 1977; DE-B 21 52 194).

Other suitable polyamides are mixed aliphatic/aromatic polycondensates, e.g. as described in U.S. Pat. Nos. 2,071,250, 2,071,251, 2,130,523, 2,130,948, 2,241,322, 2,312,966, 2,512,606, and 3,393,210, and in Kirk-Othmer, Encyclopedia of Chemical Technology, 3rd edn., vol. 18, pp. 328 ff. and 435 ff., Wiley & Sons, 1982. Other suitable polyamides are poly(etheresteramides) or poly(etheramides); products of this type are described by way of example in DE-A 25 23 991, DE-A 27 12 987 and DE-A 30 06 961.

The polyamide molding composition can either comprise one of these polyamides or two or more in the form of a mixture. As long as other thermoplastics do not impair bonding capability, up to 40% by weight of these can moreover be present, in particular impact-modifying rubbers, such as ethylene-propylene copolymers or ethylene-propylene-diene copolymers (EP-A-0 295 076), polypentenylene, polyoctenylene, random or block copolymers composed of alkenyl aromatic compounds with aliphatic olefins or dienes (EP-A-0 261 748), or core-shell rubbers with a tough, resilient core composed of (meth)acrylate rubber, of butadiene rubber, or of styrene-butadiene rubber with glass transition temperatures T_{g}<−10° C., where the core may have been crosslinked and the shell can be composed of styrene and/or of methyl methacrylate and/or of other unsaturated monomers (DE-A 21 44 528, DE-A 37 28 685).

The polyamide molding composition can receive additions of the auxiliaries and additives conventional for polyamides, examples being flame retardants, stabilizers, plasticizers, processing aids, fillers, in particular for improving electrical conductivity, reinforcing fibers, pigments, or the like. The amount added of the agents mentioned is to be such as not to give any serious impairment of the desired properties.

In one preferred embodiment, the monomer units of the polyamide which derive from diamine and dicarboxylic acid and, respectively, lactam (or aminocarboxylic acid) have an average of at least 8 carbon atoms and particularly preferably at least 9 carbon atoms.

The layer composed of the polyamide molding composition can be produced by any of the familiar industrial methods, particularly advantageously via extrusion or coextrusion.

ABS polymers have long been prior art and many commercial grades of these are available. They are in essence composed of acrylonitrile, butadiene, and styrene; this three-monomer system can be varied widely in order to meet the respective requirements. The polymer contains chains composed of polybutadiene, polyisoprene, acrylonitrile-butadiene rubber (NBR), styrene-butadiene rubber (SBR), or the like, onto which styrene, or preferably a styrene-acrylonitrile mixture has been grafted; the mixture can moreover also comprise other comonomers, e.g. methyl methacrylate.

In typical cases here, the rubber content is from 5 to 30% by weight; the matrix composed of styrene-acrylonitrile copolymer usually contains from 10 to 45% by weight and in particular from 15 to 35% by weight of acrylonitrile. As a result of the preparation process, at least some of this copolymer has been grafted onto the rubber, while the remainder is present in ungrafted form.

The ABS molding composition can comprise the usual additives, e.g. plasticizers, processing aids, flame retardants, stabilizers, antistatic agents, fillers, pigments, and reinforcing agents. Besides these, other thermoplastics can be present as constituents in the ABS molding composition, examples being polycarbonates, polyamides, or polyesters.

For the purposes of the invention, a part composed of this ABS molding composition is bonded to the layer composed of a polyamide molding composition. This part may have been shaped in the form of a sheet, for example a bodywork part of an automobile, e.g. roof module, wheel surround, engine cover, or door. Other advantageous embodiments alongside these are those in which elongate components with some degree of curvature are produced, for example cladding, e.g. the cladding of what are known as A columns on an automobile or decorative and cover strips of any type. Another example is provided by protective cladding for door sills. Alongside applications on the exterior of an automobile, constituents of the interior can also be advantageously decorated via the inventive films, in particular decorative elements such as strips and panels, because impact resistance and resistance to chemicals, such as cleaning compositions, is also a requirement in the interior. The structures listed are naturally suitable not only for use as in an automobile but also for decorative elements of any type in exterior or interior applications. In all of these cases, the part composed of the ABS molding composition forms the substrate which is bonded to the multilayer film, or it can form one layer of this film, in turn intended to be bonded to a substrate composed of an ABS molding composition.

The adhesion promoter comprises, as active agent, from 2 to 100% by weight, preferably from 3 to 80% by weight, particularly preferably from 4 to 60% by weight, and with particular preference from 5 to 40% by weight, of a copolymer, which preferably contains the following monomer units:
1. from about 70 to about 99.9% by weight, preferably from 80 to 99.4% by weight, and particularly preferably from 85 to 99% by weight, of monomer units selected from units of the following formulae:

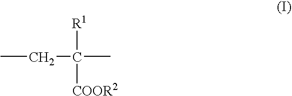

where R¹═H or CH₃ and R²═H, methyl, ethyl, propyl or butyl;

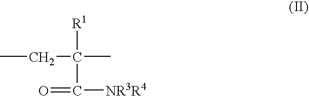

where R¹ is as above and R³ and R⁴, independently of one another, are identically H, methyl or ethyl;

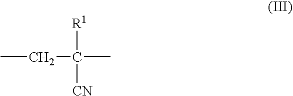

where R¹ is as above;

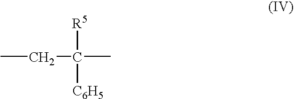

where R⁵═H or CH₃;

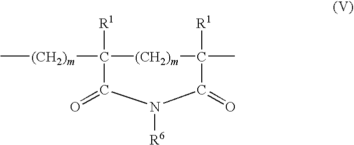

where R¹ is as above and R⁶═H, methyl, ethyl, propyl, butyl or phenyl, and m=0 or 1;
2. from about 0.1 to about 30% by weight, preferably from 0.6 to 20% by weight, and particularly preferably from 1 to 15% by weight, of monomer units selected from units of the following formulae:

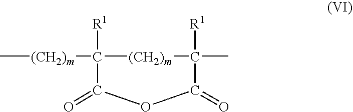

where R¹ and m are as above;

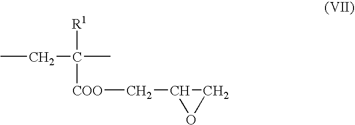

where R¹ is as above;

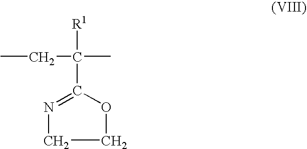

where R¹ is as above.

The reason for limiting the chain length in substituents R¹ to R⁶ is that longer alkyl radicals lead to a lower glass transition temperature and thus to lower heat resistance. This may be acceptable in a particular case; embodiments of this type are at least within the scope of equivalence of the invention.

The units of the formula (I) derive by way of example from acrylic acid, methacrylic acid, methyl acrylate, ethyl acrylate, n-butyl acrylate, methyl methacrylate, n-propyl methacrylate, or isobutyl methacrylate.

The units of the formula (II) derive by way of example from acrylamide, methacrylamide, N-methylacrylamide, N-methylmethacrylamide, or N,N-dimethylacrylamide.

The units of the formula (III) derive from acrylonitrile or methacrylonitrile.

The units of the formula (IV) derive from styrene or α-methylstyrene; these can be replaced entirely or to some extent by other polymerizable aromatics, such as p-methylstyrene or indene, which have the same effect.

If m=0, the units of the formula (V) derive from unsubstituted or substituted maleimides, such as maleimide, N-methylmaleimide, N-ethylmaleimide, N-phenylmaleimide, or N-methylaconitimide. If m=1, they derive via reaction with ammonia or with a primary amine of two adjacent units of the formula (I) in a polymer, forming an imide.

If m=0, the units of the formula (VI) derive from unsubstituted or substituted maleic anhydrides, such as maleic anhydride or aconitic anhydride. These latter compounds can be replaced entirely or to some extent by other unsaturated anhydrides, e.g. itaconic anhydride, which have the same effect. If m=1, they derive via elimination of water from two adjacent units of the formula (I) in a polymer (R²═H), with ring closure.

The units of the formula (VII) derive from glycidyl acrylate or glycidyl methacrylate, and the units of the formula (VIII) derive from vinyloxazoline or isopropenyloxazoline.

Various embodiments of the copolymer are preferred, and contain the following units:
A. from 14 to 96% by weight, preferably from 20 to 85% by weight, and particularly preferably from 25 to 75% by weight, of units of the formula (I), where R² is not H;
   from 0 to 75% by weight, preferably from 1 to 60% by weight, and particularly preferably from 5 to 40% by weight, of units of the formula (V), where m=1;
   from 0 to 15% by weight, preferably from 0 to 10% by weight, and particularly preferably from 0.1 to 7% by weight, of units of the formula (I), where R²═H;
   from 0.1 to 30% by weight, preferably from 1 to 20% by weight, and particularly preferably from 2 to 15% by weight, of units of the formula (VI), where m=1.
   If units of the formula (V) are present, these copolymers are termed polyacrylimides or polymethacrylimides or sometimes also polyglutarimides. These are products which come from polyalkyl acrylates and, respectively, polyalkyl methacrylates, in which two adjacent carboxylate groups have been reacted to give a cyclic imide. The imide is preferably formed with ammonia or with primary amines, e.g. methylamine, in the presence of water, and the units of the formula (VI) and, where appropriate, units of the formula (I), where R²═H, are produced concomitantly via hydrolysis. The products are known, as also is their preparation (Hans R. Kricheldorf, Handbook of Polymer Synthesis, Part A, Verlag Marcel Dekker Inc. New York-Basel-Hongkong, pp. 223 et seq., H. G. Elias, Makromoleküle [Macromolecules], Hüthig and Wepf Verlag Basel-Heidelberg-New York; U.S. Pat. No. 2,146,209 A; U.S. Pat. No. 4,246,374). If water only is used for the reaction, the product is units of the formula (VI) and also, if appropriate, acidic units (I) via hydrolysis, without formation of imide units (VI).
B. from 40 to 99.9% by weight, preferably from 45 to 99.4% by weight, and particularly preferably from 50 to 99% by weight, of units of the formula (IV);
   from 0 to 45% by weight, preferably from 0.1 to 40% by weight, and particularly preferably from 2 to 35% by weight, of units of the formula (III);
   from 0.1 to 30% by weight, preferably from 0.6 to 20% by weight, and particularly preferably from 1 to 15% by weight, of units of the formula (VI), where m=0.
   Copolymers of this type are obtainable in a known manner via free-radical-initiated copolymerization of aliphatically unsaturated aromatics, of unsaturated carboxylic anhydrides, and, if appropriate, of acrylonitrile or methacrylonitrile.
C. from 0.1 to 99.9% by weight, preferably from 2 to 99.4% by weight, and particularly preferably from 5 to 99% by weight, of units of the formula (I);
   from 0 to 99.7% by weight, preferably from 2 to 99.3% by weight, and particularly preferably from 4 to 98% by weight, of units of the formula (IV);
   from 0.1 to 30% by weight, preferably from 0.6 to 20% by weight, and particularly preferably from 1 to 15% by weight, of units of the formula (VI), where m=0.
   Copolymers of this type are obtainable in a known manner via free-radical-initiated copolymerization of acrylic acid, methacrylic acid, and/or esters thereof, and, if appropriate, of aliphatically unsaturated aromatics, and also of unsaturated carboxylic anhydrides.
D. from 0.1 to 99.7% by weight, preferably from 2 to 99.3% by weight, and particularly preferably from 5 to 98% by weight, of units of the formula (I);
   from 0.1 to 45% by weight, preferably from 1 to 40% by weight, and particularly preferably from 2 to 35% by weight, of units of the formula (III);
   from 0.1 to 30% by weight, preferably from 0.6 to 20% by weight, and particularly preferably from 1 to 15% by weight, of units of the formula (VI), where m=0.
   Copolymers of this type are obtainable in a known manner via free-radical-initiated copolymerization of acrylic acid, methacrylic acid, and/or esters thereof, acrylonitrile or methacrylonitrile, and of unsaturated carboxylic anhydrides.
E. ABS polymer which contains from 0.1 to 30% by weight, preferably from 0.6 to 20% by weight, and particularly preferably from 1 to 15% by weight, of units of the formula (VI), where m=0. These can have been polymerized into the chains or can have been grafted onto the chains.
F. from 0 to 99.9% by weight, preferably from 0.1 to 99.4% by weight, and particularly preferably from 2 to 99% by weight, of units selected from the formulae (I), where R² is not H, and (III),
   from 0 to 99.7% by weight, preferably from 0.1 to 99.4% by weight, and particularly preferably from 2 to 99% by weight, of units of the formula (IV),
   from 0.1 to 30% by weight, preferably from 0.6 to 20% by weight, and particularly preferably from 1 to 15% by weight, of units of the formula (VII).
G. from 0 to 99.9% by weight, preferably from 0.1 to 99.4% by weight, and particularly preferably from 2 to 99% by weight, of units selected from the formulae (I), where R² is not H, and (III),
   from 0 to 99.7% by weight, preferably from 0.1 to 99.4% by weight, and particularly preferably from 2 to 99% by weight, of units of the formula (IV),
   from 0.1 to 30% by weight, preferably from 0.6 to 20% by weight, and particularly preferably from 1 to 15% by weight, of units of the formula (VIII).

The copolymer can always contain other additional monomer units, such as those which derive from maleic diesters, from fumaric diesters, from itaconic esters, from vinyl acetate, or from ethene, as long as the desired adhesion-promoting effect is not substantially impaired thereby.

In one embodiment, the adhesion promoter can be composed entirely of the copolymer; in a variant of this, the copolymer comprises an impact modifier, e.g. an acrylate rubber.

In a second embodiment, the adhesion promoter comprises from 2 to 99.9% by weight, preferably from 3 to 80% by weight, particularly preferably from 4 to 60% by weight, and with particular preference from 5 to 40% by weight, of the copolymer, and also from 0.1 to 98% by weight, preferably from 20 to 97% by weight, particularly preferably from 40 to 96% by weight, and with particular preference from 60 to 95% by weight, of ABS.

In a third embodiment, the adhesion promoter comprises from 2 to 99.9% by weight, preferably from 3 to 80% by weight, particularly preferably from 4 to 60% by weight, and with particular preference from 5 to 40% by weight, of the copolymer, and also from 0.1 to 98% by weight, preferably from 20 to 97% by weight, particularly preferably from 40 to 96% by weight, and with particular preference from 60 to 95% by weight, of polyamide. An impact modifier, e.g. an EPM rubber, is also present, if appropriate.

In a fourth embodiment, the adhesion promoter comprises from 2 to 99.8% by weight, preferably from 3 to 80% by weight, particularly preferably from 4 to 60% by weight, and with particular preference from 5 to 40% by weight, of the copolymer, and also

from 0.1 to 97.9% by weight, preferably from 5 to 92% by weight, particularly preferably
from 10 to 86% by weight, and with particular preference from 20 to 75% by weight, of ABS, and also
from 0.1 to 97.9% by weight, preferably from 5 to 92% by weight, particularly preferably from 10 to 86% by weight, and with particular preference from 20 to 75% by weight, of polyamide.

The adhesion promoter can comprise the usual auxiliaries and additives, e.g. flame retardants, stabilizers, plasticizers, processing aids, pigments, or the like. The amount of the agents mentioned added is to be such as not seriously to impair the desired properties.

The invention further provides multilayer films which comprise at least one layer composed of a polyamide molding composition, and also comprise at least one layer composed of the inventive adhesion promoter, and also composite parts composed of this multilayer film, and also of a part composed of an ABS molding composition.

As a function of the application, the film can comprise, alongside the layers present according to the invention and composed of a polyamide molding composition and the adhesion promoter as claimed, other layers, such as a support layer composed of an ABS molding composition on the substrate side, a color layer, a functional layer, a further polyamide layer, and/or an outer layer or a clearcoat.

The color layer can be a lacquer layer; however, it is preferably composed, as in the prior art, of a colored thermoplastics layer. The thermoplastic can be a polyamide or a polymer compatible with polyamide. The colorants used can comprise organic dyes or inorganic or organic pigments.

The functional layer is a layer which has an advantageous effect on the properties of the film in relation to performance requirements, irrespective of the color, for example with regard to mechanical properties or resistance, for example to UV or heat. It can be composed of any desired molding composition which meets the performance demands and has the required adhesion to the adjacent layers, for example of polyamide, polyester, or polycarbonate.

The clearcoat can by way of example be composed, as in the prior art, of polyamide, of an acrylate polymer, of a fluoropolymer, or of a mixture thereof. It is intended to ensure that the required visual surface properties are present, and to protect the layers situated thereunder.

Examples of useful layer configurations for the inventive film are:

PA/Adhesion promoter (AP)

### PA/AP/ABS

Functional layer/PA/AP
Functional layer/PA/AP/ABS
PA/Functional layer/PA/AP
PA/Functional layer/PA/AP/ABS
Clearcoat/PA/Functional layer/PA/AP
Clearcoat/PA/Functional layer/PA/AP/ABS
Clearcoat/Functional layer/PA/AP
Clearcoat/Functional layer/PA/AP/ABS
Clearcoat/Color layer/PA/AP
Clearcoat/Color layer/PA/AP/ABS

### Clearcoat/PA/AP

### Clearcoat/PA/AP/ABS

### Clearcoat/Colored PA/AP

### Clearcoat/Colored PA/AP/ABS

By way of example, coextrusion or lamination can be used to produce the multilayer film, and, if appropriate, as in the prior art, this is followed by a process such as forming, lacquering, or surface finishing (for example by means of plasma treatment).

A peelable protective film can also be laminated onto the finished multilayer film and provides protection during transport or installation, and is peeled away after production of the composite part.

Careful balance of individual properties makes the inventive film particularly suitable for meeting the requirements placed upon materials for decorative films in the automobile exterior and automobile interior sectors. The adhesion promoter claimed ensures the presence of a reliably adhering bond between the polyamide layer and ABS, which is a frequently encountered substrate material. This applies not only in cases where ABS is brought into contact with the adhesion promoter via reverse coating by an injection-molding method, but also in cases where ABS is extruded onto the adhesion promoter, for example in a coextrusion process, or where the composite is produced via compression molding, lamination, or reverse coating by a compression-molding or foaming method. Adhesion is also ensured when, prior to reverse coating by an injection-molding process, the film is subjected to a forming process, such as thermoforming, or when the composite part is formed after production.

The examples below are intended to illustrate the invention. The following materials were used in the examples:

### 1. Clearcoat:

PA I: A PA 12 whose relative solution viscosity ηᵣₑₗ, measured in a 0.5% strength by weight solution in m-cresol at 23° C. to ISO 307, is 2.1
PA II: RILSAN® BESN TL, a PA 11 from Arkema whose relative solution viscosity ηᵣₑₗ is 2.1

### 2. Polyamide Molding Composition:

PA III: mixture composed of 20 parts by weight of a PA 12 whose relative solution viscosity ηᵣₑₗ is 2.1 and which has an excess of amino end groups, 80 parts by weight of a polyetheresteramide based on PA 12 and polytetrahydrofuran, and also 0.5 part by weight of carbon black pigment
PA IV: mixture composed of 20 parts by weight of a PA 12 whose relative solution viscosity ηᵣₑₗ is 1.9 and which has an excess of carboxy end groups, 80 parts by weight of a polyetheresteramide based on PA 12 and polytetrahydrofuran, and also 2 parts by weight of aluminum flakes
PA V: mixture composed of 100 parts by weight of PA II and 2 parts by weight of aluminum flakes

### 3. Adhesion Promoter:

AP I: mixture composed of 60 parts by weight of TERLURAN® GP22, an ABS from BASF AG, and 40 parts by weight of a copolymer whose composition is
   a) 57% by weight of monomer units of the formula

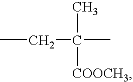

b) 30% by weight of monomer units of the formula

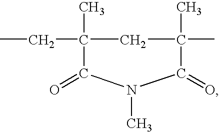

c) 3% by weight of monomer units of the formula

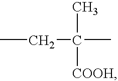

and
d) 10% by weight of monomer units of the formula

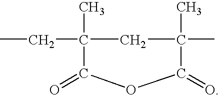

The copolymer, a polymethacrylimide, can be prepared via reaction of a melt of polymethyl methacrylate (PMMA) with an aqueous methylamine solution, for example in an extruder.
AP II: mixture composed of 55 parts by weight of a PA 12 whose relative solution viscosity ηᵣₑₗ is 1.9 and which has an excess of carboxy end groups, and 45 parts by weight of a copolymer identical with that in AP I
AP III: mixture composed of 40 parts by weight of TERLURAN® GP22, 30 parts by weight of a PA 12 identical with that in AP II, and 30 parts by weight of a copolymer identical with that in AP I
AP IV: mixture composed of 50 parts by weight of TERLURAN® GP22, 25 parts by weight of a PA 12 identical with that in AP II, and 25 parts by weight of a copolymer identical with that in AP I
AP V: (non-inventive): mixture composed of 40 parts by weight of TERLURAN® GP22 and 60 parts by weight of a PA 12 identical with that in AP II
AP VI: (non-inventive): mixture composed of 60 parts by weight of TERLURAN® GP22 and 40 parts by weight of a PA 12 identical with that in AP II
AP VII: (non-inventive): mixture composed of 50 parts by weight of TERLURAN® GP22 and 50 parts by weight of a PA 12 identical with that in AP II
AP VIII: mixture composed of 40 parts by weight of TERLURAN® GP22, 30 parts by weight of PA II, and 30 parts by weight of a copolymer identical with that in AP I

### 4. Material Used for Reverse Coating by an Injection-Molding Method:

TERLURAN® GP22G4nf, an ABS from BASF AG with 20% by Weight of Glass Fiber

The molding compositions were prepared using an Automatik ZCM 41/46-21D kneader, melt temperature being 250° C., melt throughput being 12 kg/h, and rotation rate being 250 rpm.

The multilayer films were produced on a plant from Collin, using a take-off speed of 2.5 m/min. The individual extruded layers were combined and run through a calendar. The width of the films was 24 cm.

Reverse coating by an injection-molding method took place on an Engel ES600/150 machine using a mold temperature of 80° C. and a melt temperature of 280° C. The film was cut to 100 mm×150 mm format here and placed in a mold (sheet 105 mm×150 mm×0.8-10 mm). The thickness of the sheet inclusive of film was 3 mm after reverse coating by an injection-molding method.

In order to determine resistance to separation, this being a measure for the quality of adhesion of the bond between adhesion-promoter layer and substrate, a test specimen of dimensions 10 mm×130 mm was stamped out from the sheet and subjected to a peel test. To determine quality of adhesion within the multilayer film, a test specimen with the same dimensions was stamped out from the multilayer film and a similar procedure was used. If there is good adhesion between the bond partners studied, one end of the test specimen was kept in hot polyethylene glycol for 30 minutes in order to initiate separation. Once separation had been initiated, the test specimen was clamped into the chucks of the test machine with an angle of 180° between the layers to be separated. The chucks then separated at a velocity of 50 mm/min, thus subjecting the test specimen to severe peel conditions. The separation resistance exerted by the composite in the face of these peel conditions was recorded. This was achieved by measuring the separation force needed for separation in N. Separation resistance was determined from this by suppressing separation force measured in relation to the specimen width, by taking the quotient. Specimen width was always 10 mm, and separation resistance therefore has the unit N/mm. It is regarded as sufficient if it is at least 3 N/mm.

### INVENTIVE EXAMPLES 1-6 AND COMPARATIVE EXAMPLES A-C

Table 1 gives the structure of the composite parts produced, and also the results.

TABLE 1
Structure of composite parts and results

| | Example | | | | | | | | |
|---|---|---|---|---|---|---|---|---|---|
| | 1 | 2 | 3 | 4 | A | B | C | 5 | 6 |
| Clearcoat (100 μm) | — | — | PA I | PA I | — | — | — | PA I | PA II |
| Polyamide layer (200 μm) | PA III | PA IV | PA IV | PA III | PA IV | PA IV | PA IV | PA III | PA V |
| Adhesion promoter (200 μm) | AP I | AP II | AP III | AP IV | AP V | AP VI | AP VII | AP III | AP VIII |
| ABS layer (200 μm) (TERLURAN ® GP22) | − | − | − | − | − | − | − | + | − |
| Material used for reverse coating by an injection- | + | + | + | + | + | + | + | + | + |
| molding method (= substrate) | | | | | | | | | |
| Adhesion of adhesion promoter to polyamide layer | ns¹⁾ | ns¹⁾ | ns¹⁾ | ns¹⁾ | 2.8 | 0.1 | 0.5 | ns¹⁾ | ns¹⁾ |
| [N/mm] | | | | | | | | | |
| Adhesion of adhesion promoter to substrate or to | ns¹⁾ | 3.5 | ns¹⁾ | ns¹⁾ | na²⁾ | 0.9 | na²⁾ | ns¹⁾ | ns¹⁾ |
| ABS layer [N/mm] | | | | | | | | | |

¹⁾no separation of bond partners, but cohesive failure of film layers
²⁾no adhesion

What is claimed is:

1. A composite part comprising:
a part composed of an ABS molding composition, and
a multilayer film comprising:
at least one layer comprising a polyamide molding composition, and
at least one layer comprising an adhesion promoter,
wherein said adhesion promoter comprises from 2 to 100% by weight of a copolymer comprising:
from 70 to 99.9% by weight of monomer units derived from vinyl compounds selected from the group consisting of acrylic acid derivatives, methacrylic acid derivatives, and vinylaromatics; and
from 0.1 to 30% by weight of monomer units comprising a functional group selected from the group consisting of a carboxylic anhydride group, an epoxy group, and an oxazoline group.

2. The composite part according to claim 1, wherein the copolymer comprises:
a) from 70 to 99.9% by weight of one or more monomer units selected from the group consisting of formula (I), formula (II), formula (III), formula (IV) and formula (V): 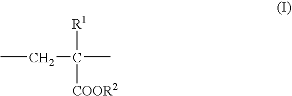
where R¹═H or CH₃ and R²═H, methyl, ethyl, propyl or butyl; 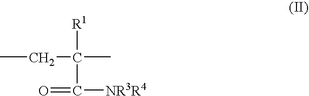
where R¹═H or CH₃ and R³ and R⁴, independently of one another, are H, methyl or ethyl; 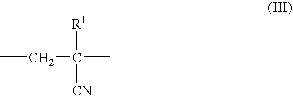
where R¹═H or CH₃; 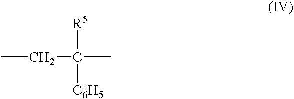
where R⁵═H or CH₃; and 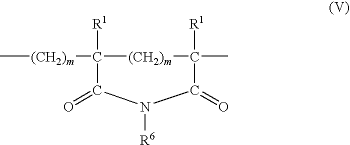
where R¹═H or CH₃ and R⁶═H, methyl, ethyl, propyl, butyl or phenyl, and m=0 or 1; and
b) from 0.1 to 30% by weight of one or more monomer units selected from the group consisting of formula (VI), formula (VII) and formula (VIII): 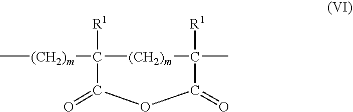
where R¹═H or CH₃ and m=0 or 1; 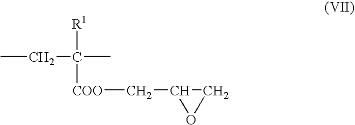
where R¹═H or CH₃; and 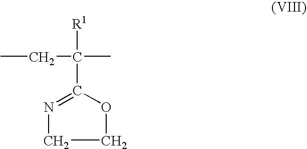
where R¹═H or CH₃.

3. The composite part according to claim 1, wherein the adhesion promoter comprises:
from 2 to 99.9% by weight of the copolymer, and
from 0.1 to 98% by weight of ABS.

4. The composite part according to claim 1, wherein the adhesion promoter comprises:
from 2 to 99.9% by weight of the copolymer, and
from 0.1 to 98% by weight of polyamide.

5. The composite part according to claim 1, wherein the adhesion promoter comprises:
from 2 to 99.8% by weight of the copolymer,
from 0.1 to 97.9% by weight of ABS, and
from 0.1 to 97.9% by weight of polyamide.

6. The composite part according to claim 1, wherein the multilayer film further comprises one or more layers selected from the group consisting of an ABS layer, another polyamide layer, a color layer, a functional layer, and a clearcoat layer.

7. The composite part according to claim 1, wherein the ABS molding composition comprises one or more additional thermoplastics.

8. The composite part according to claim 1, wherein the part composed of an ABS molding composition has been shaped in the form of a sheet.

9. The composite part according to claim 1, wherein said part is a bodywork part of an automobile, is a cladding, is a decorative strip, is a cover strip, is a panel, or is a decorative element.
